(19) United States
(12) Patent Application Publication
(10) Pub. No.: US 2003/0202518 A1
(43) Pub. Date: Oct. 30, 2003

(54) State-based policy management method for a communications transport network, a network element and a policy server for its implementation

(75) Inventors: Massimo Canali, Vimercate (IT); Paolo Molgora, Settala (IT)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/408,554

(22) Filed: Apr. 8, 2003

(30) Foreign Application Priority Data
Apr. 25, 2002 (EP) 02291057.4

(51) Int. Cl. H04L 12/66

(52) U.S. Cl. 370/395.21

(57) ABSTRACT

In a communications transport network (ITN) of the type comprising a plurality of network elements (NE), a policy network is provided comprising a policy server (PS) and a plurality of policy clients (PC) associated to network elements (NE) of the transport network (ITN); users of the transport network (ITN) are able to directly provision communications transport services. When a connection within the transport network (ITN) is removed, the or each policy client (PC) associated to this connection causes the deletion of the or each state associated to this connection within the policy server (PS) and thereafter the policy server (PS) considers this connection as removed.

### INCORPORATION BY REFERENCE OF PRIORITY DOCUMENT

This application is based on and claims the benefit of European Patent Application No. 02291057.4 filed on Apr. 25, 2002, which is incorporated by reference herein.

### BACKGROUND OF THE INVENTION

1. Field of the Invention

The present invention relates to a state-based policy management method for a communications transport network according to the preamble of claim 1, and to a network element and a policy server according to the preamble of respectively claims 5 and 9.

2. Description of the Prior Art

Traditional communications transport networks provide for rigid communications services. The so-called “intelligent transport networks” will provide for flexible communications services.

Additionally, in these new communications transport networks the users will be able to directly provision its communications transport services while in the traditional networks the provisioning of services is done in a centralised way by a network management application. To this regard, the International Telecommunication Union [ITU] has recently carried out some standardisation activity relating to the so-called “Automatic Switched Transport Networks” [ASTN]. For the sake of precision, till now, the standardisation activity of ITU relating to a new generation of communications transport networks was mainly concentrated on the so-called “Optical Transport Networks” [OTN], probably because future communications transport networks will be very often realised through optical fibres.

For the Internet network, the Internet Engineering Task Force [IETF], a well known international community concerned with the evolution of the Internet architecture and operation, proposed a network-control protocol, called “RSVP”, in order to enable Internet applications to obtain different qualities of service for different types of data flows; this was done particularly in view of the transmission of real-time and high-bandwidth information over the Internet. RSVP allows an Internet application to reserve some network resources for carrying out an own transmission; RSVP provides for periodic refresh messages in order to maintain those resources as reserved; in the absence of refresh messages those resources are freed.

Recently, IETF has proposed an architecture and a protocol, called “COPS”, for policy control suitable for the Internet network, as respectively described in documents RFC 2753 and RFC 2748; additionally; this architecture provides for a policy server and a plurality of policy clients; IETF has also provided for an extension of RSVP for allowing policy control, and for usage directives of COPS for RSVP environments, as respectively described in documents RFC 2750 and RFC 2749.

All the above cited documents are incorporated herewith by reference.

Any communications transport network, and particularly an Intelligent Transport Network [ITN] whether optical or not, requires policy control; in other words, the network must have the possibility to determine whether or not access and usage of a internal network resource should be granted to a network user that is external to the network. In order to be able to use communications transport services provided by the network, a user needs a Service Level Agreement [SLA].

Particularly in those cases when a user frequently and/or directly requests and releases various network resources, it is important that the entity or entities in charge of policy management be promptly informed of any successful request and release by a user. Such cases were extremely rare in the traditional transport networks where provisioning of services was done in a centralised way by a network management application, and the solution to this problem was simple: the centralised network manager informed the centralised policy manager of any change in resources allocation.

The idea of applying the abovementioned solutions devised for the Internet network to the communications transport networks leaves a very important problem unresolved: how and when to inform the policy server that a connection within the transport network has been removed.

Of course it would be possible that the policy server checks directly with the transport network the status of the connections within the network and then updates its archives; anyway, this solution would imply a lot of work and some updating delay.

### SUMMARY OF THE INVENTION

It is the object of the present invention to provide a simpler solution to the abovementioned problem.

This object is substantially achieved by the policy management method having the functionalities set out in independent claim 1.

The basic idea underlying the present method is that, when a connection within the transport network is removed, the or each policy client associated to such connection causes the deletion of policy information associated to such connection within the policy server and thereafter the policy server considers such connection as removed.

Further advantageous functionalities of the present method are set out in the dependent claims.

According to further aspects, the present invention relates also to a network element and to a policy server for implementation of the present method and having respectively the features set out in independent claims 5 and 9; further advantageous features of the element and of the server are set out in the respective dependent claims.

### BRIEF DESCRIPTION OF THE DRAWINGS

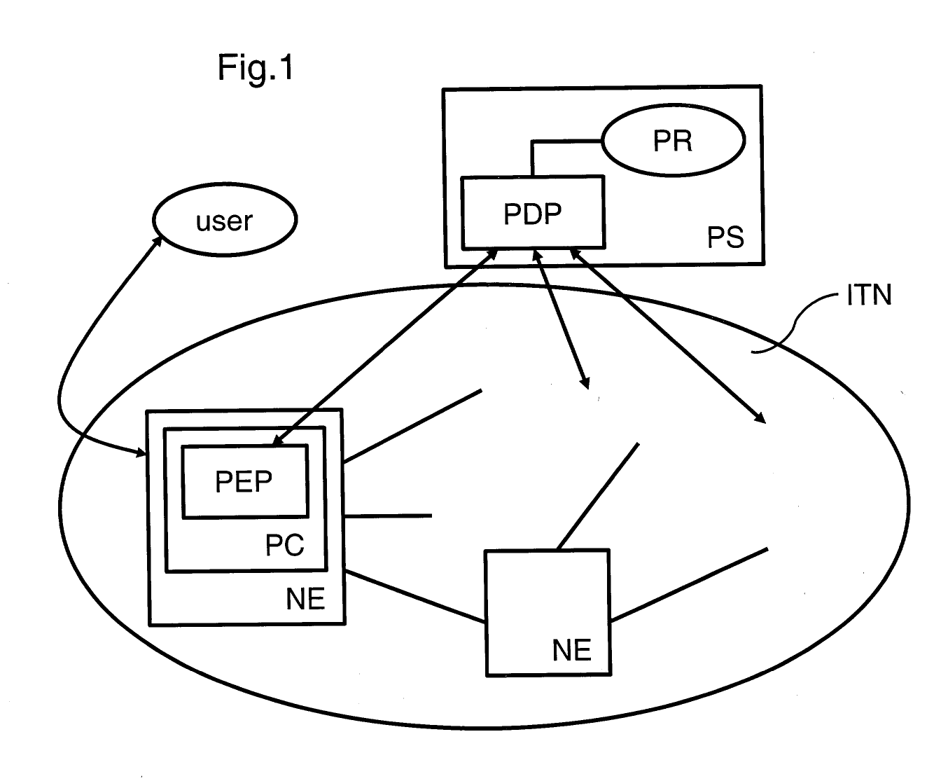

The invention will become more apparent from the following description to be considered in conjunction with the accompanied drawing wherein FIG. 1 shows a block diagram of an intelligent transport network ITN provided with a policy server PS, where, for example, the present invention may be used; a network user is also schematically shown in FIG. 1.

### BEST MODE FOR CARRYING OUT THE INVENTION

Network ITN comprises a plurality of network elements NE; for simplicity, only two network elements NE are shown in FIG. 1 and only for one of them some internal details are shown; the physical connections of the network elements are shown only schematically.

Network ITN may be, for example, an Intelligent Optical transport Network [ION].

Network ITN is managed from an administrative point of view by a policy management application. To this purpose, network ITN comprises a policy server PS and some of the network elements NE of network ITN comprise an own policy client PC. Policy server PS is connected to and in communication with policy clients PC. In the example of FIG. 1, the policy architecture corresponds to the architecture described in IETF document RFC 2753 and policy communication takes place according to COPS protocol as described in IETF document RFC 2748; both of them are incorporated herewith by reference.

Policy server PS is the entity of network ITN who has the task of managing the service level agreements [SLA] of the users of network ITN. To this purpose, policy server PS comprises a policy decision point application PDP which is, for example, basically implemented as a software process and a policy repository PR for storing at least information relating to service level agreements.

Policy clients PC are the entities of network ITN who have the task of enforcing service level agreements [SLA], i.e. to ensure that a user may obtain and use a service only in accordance with his service level agreement. To this purpose, policy client PC comprises a policy enforcement point application PEP which is, for example, basically implemented as a software process.

For the sake of precision, policy communication takes place between policy decision point application PDP and policy enforcement point applications PEP through COPS protocol.

Policy management takes place within network ITN through an exchange of messages between applications PEP and application PDP; according to a simplified description of the policy management activity, an application PEP sends request messages to application PDP and application PDP replies to that application PEP with decision messages; both the PEP and the PDP keeps track of the request/decision pairs as state information; states from various events (request/decision pairs) may be inter-associated. In general, the installation of a new connection within the network implies a number of events. According to COPS protocol, a handle uniquely identifies a state for both a PEP and the PDP. PDP may store state information inside repository PR.

The policy management method according to the present invention is based on the use of state information; it is suitable for a communications transport network comprising a plurality of network elements and wherein it is provided that users of the transport network directly provision communications transport services; additionally, it is adapted to be implemented within a policy network comprising a policy server and a plurality of policy clients associated to network elements of the transport network.

In order to achieve the abovementioned object, the method according to the present invention provides that when a connection within the transport network is removed, the or each policy client associated to such connection causes the deletion of the or each state associated to such connection within the policy server and thereafter the policy server considers said connection as removed.

In order to have a short delay between the time when the connection is removed within the network and the time when the policy server is aware of that, it may be advantageously provided that the policy server considers the connection as removed as soon as the last state associated to such connection is deleted. This may be achieved, for example, in the following way: when the program code portion (e.g. a subroutine or a process) running inside of the policy server and in charge of deleting state information receives a state deletion request, it deletes the state, it determines whether a connection is associated to such state and, in the affirmative, it checks whether there remains at least one state associated to such connection within the policy server; if this does not happen, i.e. if that was the last state associated to that connection, it signals that that connection has been removed within the network.

If the policy server comprises a policy repository, when the policy server considers a connection as removed it may advantageously update its policy repository.

In order to guarantee that the users of the network fully exploit their SLAs at any time, the method according to present invention advantageously provide that when the policy server considers a connection as removed it updates user information within its policy repository for all policy clients associated to the removed connection; for example, if a user, according to its SLA, is authorised to have a certain number of connections and to use certain resources of the network for its connections, when a connection requested by that user is removed, the policy server may update its policy repository by increasing the number of connections still available for that user and by marking the released resources as available for connections.

In order to implement the method according to the present invention, both the network elements and the policy server have to be appropriately designed and realized.

The network element according to the present invention, comprises a policy client adapted to co-operate with a policy server of the transport network in order to implement a state-based policy management method.

In order to be adapted to implement the method according to the present invention, the network element comprises further means for sending at least one request of policy state deletion to the policy server when a connection within the transport network is removed; the number of state deletion requests may depend on the specific implementation of the method and/or on the specific connection that has been removed.

If the network element comprises also means for internally storing policy states associated to connections within the transport network, and means for internally deleting the or each policy state associated to a removed connection within the transport network, the sending means may be further advantageously adapted to request the policy server to internally delete the or each policy state associated to the removed connection within the transport network.

In the case of COPS model, as there is perfect correspondence between the states of the policy client and the states of the policy server, the policy client can precisely specify (through the unique handler) which states to delete.

Such a network element may be further adapted for the implementation of the various other functionalities of the method according to the present invention.

The policy server according to the present invention is adapted to cooperate with the policy clients of the transport network in order to implement a state-based policy management method.

In order to be adapted to implement the method according to the present invention, the policy server comprises means for receiving from the policy clients requests of policy state deletion, and means for processing such deletion requests, adapted to understand when a connection within the transport network has been removed.

If the policy server comprises also means for storing policy states associated to connections within the transport network, and means for deleting policy states associated to connections within the transport network, the processing means may be further advantageously adapted to check when the or each policy state associated to a connection has been deleted and to derive therefrom that such connection has been removed.

In the case of COPS model, as there is perfect correspondence between the states of the policy client and the states of the policy server, the policy server can receive from the policy clients precise specification (through the unique handler) of the states that have to be deleted.

Such a policy server may be further adapted for the implementation of the various other functionalities of the method according to the present invention.

The method and the apparatuses according to the present invention may be implemented partly or entirely in software.

Therefore, a first further aspect of the present invention consists in a processor program product comprising program code portions adapted for the implementation of the method according to the present invention when executed by a processor.

A second further aspect of the present invention consists in memory means storing a processor program product comprising program code portions adapted for the implementation of the method according to the present invention when executed by a processor.

There has thus been shown and described a novel State-based policy management method for a communications transport network, and a novel network element and policy server for its implementation, which fulfill all the objects and advantages sought therefor. Many changes, modifications, variations and other uses and applications of the subject invention will, however, become apparent to those skilled in the art after considering the specification and the accompanying drawings which disclose preferred embodiments thereof. All such changes, modifications, variations and other uses and applications which do not depart from the spirit and scope of the invention are deemed to be covered by the invention which is limited only by the claims which follow.

What is claimed is:

1. A state-based policy management method for a communications transport network comprising a plurality of network elements and wherein it is provided that users of the transport network directly provision communications transport services, the method being adapted to be implemented within a policy network comprising a policy server and a plurality of policy clients associated to network elements of the transport network, wherein when a connection within the transport network is removed, the or each policy client associated to said connection causes the deletion of the or each state associated to said connection within the policy server and thereafter the policy server considers said connection as removed.

2. A method according to claim 1, wherein the policy server considers said connection as removed as soon as the last state associated to said connection is deleted.

3. A method according to claim 1, wherein the policy server comprises a policy repository and wherein when the policy server considers a connection as removed it updates its policy repository.

4. A method according to claim 3, wherein when the policy server considers a connection as removed it updates user information within its policy repository for all policy clients associated to the removed connection.

5. A network element for a communications transport network, comprising a policy client adapted to co-operate with a policy server of the transport network in order to implement a state-based policy management method, wherein it comprises further:
a sending element of at least one request of policy state deletion to the policy server when a connection within the transport network is removed.

6. A network element according to claim 5, wherein it comprises further:
an internal memory storing policy states associated to connections within the transport network (ITN), and
an element for internally deleting the or each policy state associated to a removed connection within the transport network;
wherein said sending element is adapted to request the policy server to internally delete the or each policy state associated to said removed connection within the transport network.

7. A network element according to claim 5, wherein said sending element is adapted to implement COPS protocol.

8. A network element adapted for the implementation of the method according to any of claims from 1 to 4.

9. A policy server for a communications transport network, said network being of the type comprising a plurality of network elements and a plurality of policy clients associated to network elements of the network, the policy server being adapted to co-operate with the policy clients in order to implement a state-based policy management method, wherein it comprises:
a receiver for receiving from the policy clients requests of policy state deletion, and
a processor for processing said deletion requests, adapted to understand when a connection within the transport network has been removed.

10. A policy server according to claim 9, comprising further:
a second memory for storing policy states associated to connections within the transport network,
a second element for deleting policy states associated to connections within the transport network;
wherein said processor is adapted to check when the or each policy state associated to a connection has been deleted and to derive therefrom that said connection has been removed.

11. A policy server according to claim 9, wherein the said receiver is adapted to implement COPS protocol.

12. A policy server according to claim 9, wherein it is adapted for the implementation of the method according to any of claims from 1 to 4.
